(19) United States
(12) Patent Application Publication
(10) Pub. No.: US 2019/0168534 A1
(43) Pub. Date: Jun. 6, 2019

(54) CNC Marking Device

(71) Applicant: Edward Pryor & Son Limited, Sheffield (GB)

(72) Inventors: David Ray, Sheffield (GB); Richard Smith, Sheffield (GB)

(21) Appl. No.: 15/832,597

(22) Filed: Dec. 5, 2017

(51) Int. Cl. B44B 3/06

(52) U.S. Cl. CPC B44B 3/061

(57) ABSTRACT

A CNC machine comprises a holder for a workpiece to be machined, a tool array comprising one or more tools, a machining arm adapted to select and use one of said one or more tools to machine said workpiece, and a marking device positionable in said tool array and selectable by said machining arm. The marking device comprises an optionally fluid-sealed housing and a marking head mounted in housing for translational movement in a marking plane. The marking head has a marking tip, being moveable in a marking direction substantially orthogonal to said marking plane for marking said workpiece. A controller is used for controlling the translational movement of the marking head and the marking pin. A communicator enables communication externally at least to operate the marking tip but also preferably said translational movement to describe the desired shape of mark to be made.

### FIELD OF THE INVENTION

This invention relates to a CNC (computer numerically controlled) marking device adapted for use in a CNC machine.

### BACKGROUND

CNC (computer numerically controlled) machines are used to form complex parts that are machined in a single operation using more than one tool. The machine selects a tool from a bank of tools that are at its disposal. For example, the machine may select a milling tool to form a profile on a workpiece and then subsequently select a drill tool to form holes in that workpiece and substantially complete the part. Commonly the single operation is performed in a closed environment, which is furnished with cooling/lubricating fluids used to aid the machining.

Parts that are machined using a CNC machine often need to be traced. This may be, for example, to ensure batch identification should one part of a batch develop a fault. To trace such parts they are often marked with an identification code. This process is often completed using a marking machine that each part is placed into. However, the simple movement of each part from one machine to the next may result in damage to the part if it is dropped or accidently bumped into other objects. It is for this reason that CNC machines are able to perform more than one section of the machining process. Returning to the above example, a margin for error would be introduced to the machining operation if the milling was performed in a different machine to the drilling.

It is therefore desirable to mark each part as it is formed. However, as mentioned, the CNC machine environment is closed and contains fluid and debris.

EP1361960 describes a handheld marking device that may be used to mark a surface for permanent identification purposes. Such a device may therefore be used to mark each part formed by the CNC machine. This could be a manual or semi-automated, i.e. robotic, operation that takes place as each part is unloaded from the CNC machine and therefore, in some circumstances, eliminates the need for a static marking machine in which each part must be loaded. However, such an operation still requires transportation of the part from the CNC closed environment to an area accessible by the marking machine.

US2010/0275794 describes a CNC machine having a gantry on which is mounted tooling, to effect working on a workpiece mounted on a tooling table, and a carriage, holding a marking device. A marker controller operates the marking device to mark a workpiece with data derived from a CNC controller and from an HMI device. Such an arrangement is complicated but can be simplified.

It is an object of the present invention to address the problems identified above, or at least to mitigate their effects.

### SUMMARY

In accordance with the present invention there is provided CNC machine comprising: a holder for a workpiece to be machined; a tool array comprising one or more tools; a machining arm having a first connector and adapted to select and use one of said one or more tools to machine said workpiece; and a marking device having a second connector and positionable in said tool array and selectable by said machining arm by interengagement of said first and second connectors, wherein said marking device comprises: a housing; a marking head mounted in said housing, said marking head comprising a marking tip being moveable in a marking direction for marking said workpiece; a controller for controlling said marking pin; and a wireless communicator adapted to receive instructions from a transmitter unit, said instructions being passable to said controller to instruct said controller to control said movement of said marking tip.

Said wireless communicator may comprise a wireless communicator such as, for example, a Bluetooth® module. The wireless communicator may be further adapted to transmit data indicating the current or historic movement of said marking head and/or said marking tip.

The machine may further comprise a computer adapted to transmit said instructions to said wireless communicator. Said computer may be further adapted to receive said data indicating the current or historic movement of said marking head and/or said marking tip.

Said wireless communicator might be pneumatically or hydraulically driven through connection of the machining arm to the marking device and under the control of a controller of the CNC machine that controls said machining arm.

The marking device may further comprise a support frame on which said housing is mounted substantially enclosing said support frame, said frame providing a mount for said marking head and said controller. The housing may comprise a body, a base and a lid, wherein said base and said lid are fixable to said frame and said body is positionable between said base and said lid, so that fixation of said base and lid to said support frame clamps said body and forms said housing, which is preferably fluid-sealed.

The marking tip is preferably moved by electromagnetic means.

The marking device may include its own power source, which may be activated and deactivated by connection to said machining arm of the marking device.

The housing may also comprise a window through which said marking head and/or marking tip protrudes, a gaiter being connected between said marking head and said window to fluid-seal for said window.

Preferably, the marking head is also mounted for translational movement in a marking surface under the control of said controller, said marking surface being substantially orthogonal with respect to said marking direction.

The marking surface may be planar and said translational movement may be effected by a first motor and a second motor wherein said first motor is adapted to move said marking head in a first direction in said marking plane and said second motor is adapted to move said marking head in a second direction in said marking plane, wherein said first direction is substantially perpendicular to said second direction.

Said first and second motors may be fixed in the support frame and drive belts that slide a marking head mount in said first and second directions.

Alternatively, said marking surface may be cylindrical and said translational movement is effected by a first motor and a second motor. The first motor may be disposed on a tilting frame pivoted in the support frame, the first motor being arranged to tilt the tiling frame in a first direction with respect to the support frame, and the second motor may be mounted on a slide mount slidable by operation of the second motor in a second direction substantially orthogonal with respect to said first direction, the slide mount mounting said marking head.

The invention also provides a marking device suitable for use in a CNC machine as defined above, the marking device comprising: a marking head mounted in a housing of the device, said marking head comprising a marking tip being moveable in a marking direction for marking said workpiece; a controller for controlling said movement of said marking pin; and a wireless communicator adapted to receive instructions from a transmitter unit, said instructions being passable to said controller to instruct said controller to control said movement of said marking tip.

The marking head may be mounted for translational movement in a marking surface under the control of said controller, said marking surface being substantially orthogonal with respect to said marking direction. The device may further comprise an on-board power source to power the controller and drive said marking head. The marking device may further comprise a pneumatically operated switch adapted for operation by a pneumatic source of a CNC machine to connect said power source to and disconnect said power source from the controller and marking head.

The invention also provides a method of marking a workpiece in a CNC machine comprising: a holder for said workpiece; a machining arm adapted to select and use a tool to machine said workpiece; and a marking device selectable by said machining arm, said marking device comprising a marking head having a marking tip being movable in a marking direction under the control of a controller, and a wireless communicator connected to said controller; wherein said method comprises the steps of:
a) the CNC machine selecting said marking device using said machining arm;
b) the CNC machine positioning said marking device with respect to said workpiece;
c) communicating with said wireless communicator to initiate marking;
d) the controller moving said marking tip in said marking direction to produce a mark on said workpiece; and
e) optionally, repeating steps b), c) and d).

Said marking head may be movable in the marking device in a marking plane being substantially orthogonal with respect to said marking direction, the method further comprising the step of:
f) before step d), the controller moving said marking head in said marking plane while retaining the position of said marking device.

The method may further comprise the step of:
g) repositioning said marking device so that a camera of said marking device is able to obtain an image of said mark.

Step c) may further comprise activating a power source in the marking device. In which case, said activation of the power source may be effected pneumatically under the control of the CNC machine.

Said controller may receive instructions from a computer remote from said marking device outside of said CNC machine. The method may further comprise the steps of:
i. transmitting a signal from said wireless communicator to said computer to indicate that said marking device has been activated;
ii. transmitting said instructions from said computer to said marking device;
iii. performing step d) and, optionally, step f); and
iv. transmitting a signal from said wireless communicator to said computer to indicate that said mark has been produced.

Optionally, step g) further comprises the steps of:
i. said repositioning of said marking device so that a camera of said marking device is able to obtain an image of said mark;
ii. transmitting a signal from said computer to said marking device containing further instructions for said controller to operate said camera to obtain said image;
iii. transmitting said image from said controller to said computer; and
iv. said computer checking said image.

After checking the image, the computer may notify the CNC machine that the power source is to be deactivated.

### DRAWINGS

These and other features, aspects, and advantages of the present invention will become better understood with regard to the following description, appended claims, and accompanying drawings, where:

FIG. 1 is perspective view of a marking device for a CNC machine according to an embodiment of the present invention;

FIG. 2 is a perspective view of a marking device for a CNC machine according to an embodiment of the present invention;

FIG. 3 is a perspective view of internal features of a marking device for a CNC machine according to an embodiment of the present invention;

FIG. 4 is a perspective view of a marking device for a CNC machine according to another embodiment of the present invention;

FIG. 5 is a side view of the marking device of FIG. 4; and

FIG. 6 is a schematic illustration of a CNC machine in accordance with embodiment of the invention.

### DESCRIPTION

The following description provides detailed examples of some embodiments of the present invention.

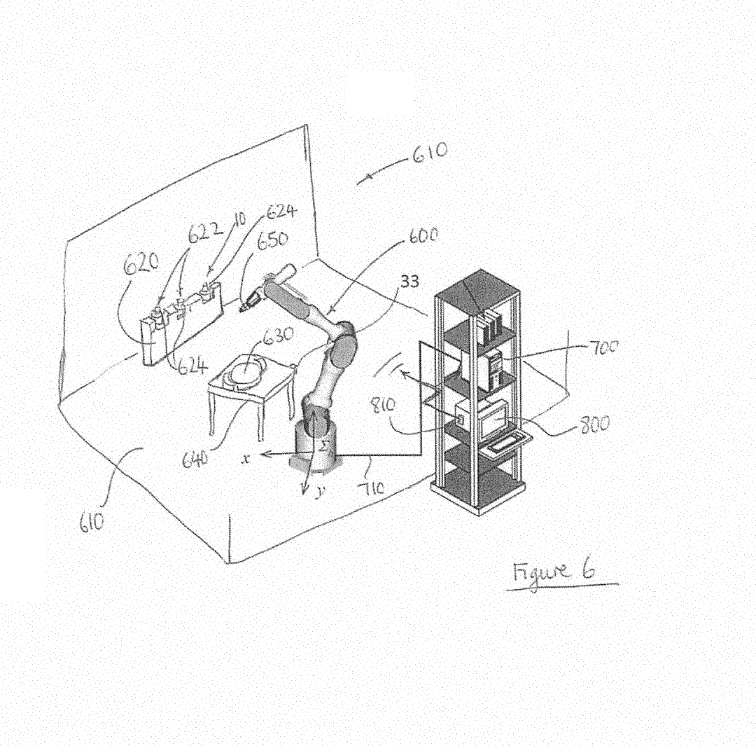

In FIG. 6, a CNC machine includes an enclosed room 610 in which is disposed a robotic machining arm 600 fixed in place on a floor 612 of the room 610. The arm 600 is movable in multiple directions and orientations (x, y, z directions) with respect to a workpiece 630, which may be disposed and fixed by a clamp on a work table 640. The arm 600 has on its end a universal first connector 650, arranged to interconnect with a second connector on a specific tool for performing a specific function (machining operation) with respect to the workpiece 630. A tool array 620 locates a plurality of different tools 622, each having a said second connector 624. Each tool 622 is potentially for performing a different role, for example, drilling, milling, grinding etc. It is feasible that the tool array 620 may be located outside the room 610 and is only brought into the machining room 610 when a new tool is required. This is because machining frequently involves washing the workpiece with coolant during machining, which frequently leads to the room 610 becoming splashed with coolant that may be deflected by each tool as they operate on the workpiece.

The machining arm 600 operates under the control of a CNC controller 700, located outside of the room but most likely hardwired to the arm by a line 710. Other supply lines (not shown) may connect to the machining arm to supply hydraulic power, pneumatic power or electrical power to the arm, and to a tool 622 connected to the arm.

A marking device 10 comprises one of the tools 622, in accordance with an embodiment of the present disclosure, which is selectable by the machining arm as and when required under the control of the CNC controller 700. It also has a corresponding second connector 624 for engagement with the first connector 650. As described below, the marking device may include an on-board power source that is activated when the device 10 is engaged by the arm 600. It also includes a wireless communicator (described further below) that is adapted to receive signals from, and optionally transmit signals to, an external controller 800, which may be a personal computer or other device having an antenna 810.

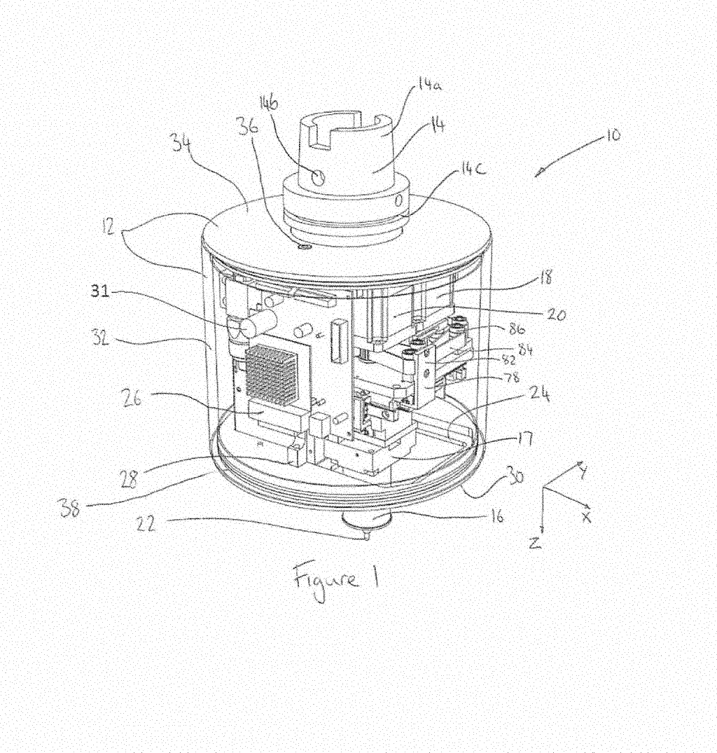

FIG. 1 shows a marking device 10 for use by a machining arm of a CNC (computer numerically controlled) machine (not shown in FIG. 1). The CNC machine, as known, comprises a means for holding a workpiece (for example, a clamp), a tool array and the machining arm, all within a closed environment. The environment is usually populated with fluids and debris formed as a result of the machining process. The marking device 10 is used to mark a workpiece machined in the CNC machine with a unique code. This often takes the form of a matrix of dots but other codes are within the scope of this invention. Such dots may be formed as impressions in the workpiece by a tip formed of a hardened material that is located over the workpiece in a predetermined location and then punched into the surface of the workpiece.

According to some embodiments of the present invention, the marking device 10 comprises a housing 12, which forms a, preferably, fluid-sealed environment. A fluid resistant housing is potentially satisfactory since tool arrays in CNC machines (where the marking device 10 might be stored when not in use) are generally isolated from the area of the machine where machining of the workpiece takes place and a hot wet environment pertains. Also, during use of the marking device, any fluid lubricant or cooling supply would likely be disengaged. Hence absolute fluid-sealing is not essential.

A first connector 14 is positioned at the top end of the marking device relative to a marking head 16 as used to mark the workpiece. The connector preferably comprises a collar 14a adapted to engage with a second connector (not shown) on the machining arm (not shown) of the CNC machine. The machining arm further comprises locking means positionable inside lugs 14b. The marking device is storable in the array of tools inside the CNC machine. A reveal 14c (optionally in the form of a cylindrical groove) in the connector is adapted to be engaged by a forked bracket on which the marking device is stored after disconnection from the shaft of the machining arm.

The marking head 16 of the marking device 10 is mounted inside the housing 12 and is moveable in a marking plane (x, y). Movement within the plane is effected by movement in a first direction x and a second direction y, the second direction y being substantially perpendicular to the first direction x. Movement in the first direction x is effected by a first motor 18 and movement in the second direction y is effected by a second motor 20.

The marking head comprises a marking tip 22, which is used to mark the workpiece. The head 16 projects from the housing 12 through a marking window 24. Marking is performed by moving the marking tip 22 in a marking direction z onto the workpiece using, for example, electromagnetic means such as a solenoid. Alternative means of moving the marking tip are described below. A power regulator 26 is also mounted inside the housing 12 and is used to supply electrical power to move the first and second motors 18, 20 and optionally the marking tip 22. The electrical power may be supplied by the machine arm or could, as described below, be supplied by an on-board power source such as a battery.

In some embodiments, the marking device also comprises a frame 28 positioned inside the housing to provide a support for the housing and a mount for the marking head, first and second motors and the power regulator 26. The frame may be of metal construction and may be of, but is not restricted to, a planar construction. The housing 12 comprises a base 30, a cylindrical body 32 and a lid 34. The base 30 and the lid 34 provide a clamp for the body 32 when the base and the lid are fixably attached to the frame 28. Suitable fixings may be, for example, bolts or screws 36. The clamping of the body 32 between the base and the lid provides a fluid-sealed housing. O-rings 38 provided at the junction between the base and the body, and the lid and the body enhance the fluid seal. A flexible gaiter (not shown) is attached between the window 24 and the marking head 16 so as to provide a fluid seal over the marking window region.

As mentioned above, the body may be cylindrical in shape wherein the combination of the frame and the clamping arrangement provides a strong rigid configuration. The frame provides a transfer of force from the marking tip as it impacts the workpiece to the machining arm.

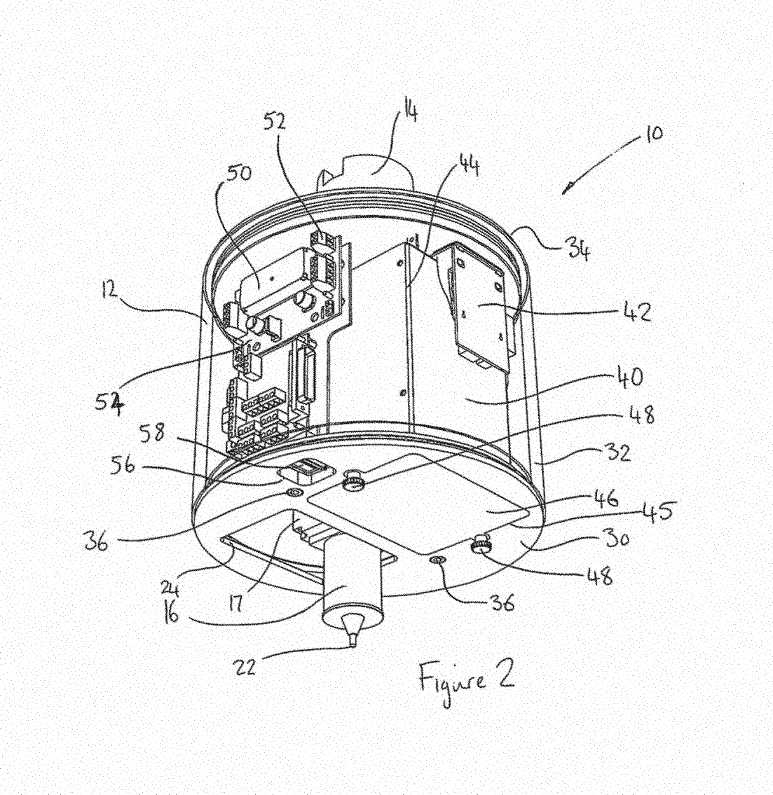

Turning to FIG. 2, the marking device 10 further comprises a power source 40 enclosed within the housing 12. The power source is preferably a rechargeable battery capable of supplying power to the first and second motors (see FIG. 1) and, optionally, the marking head 16. The battery is removably placed into a holder 44 via a battery window 45 positioned in the base 30 adjacent to the window 24 for the marking means. The battery window 45 is covered by a battery cover 46 which is held in place by screws 48, screwable into the base 30. An O-ring may be supplied around the battery window 45 to enhance the seal made between the cover 46 and the base 30.

In some embodiments, the marking device comprises a controller 50 adapted to control the first and second motors to effect movement of the marking head. As used herein, a “controller” is something that directs or regulates something, such as, for example, a motor. A controller can be used in connection with software that directs the controller's function. A controller can include memory such as a random access memory chip. A controller can be a microcontroller (or MCU for microcontroller unit) that contains one or more CPU cores, and may include memory and programmable input/output peripherals or a similar programmable controller on a single integrated circuit, including a system on a chip or SoC, or state machine.

The controller may be a pre-programmed computer that is able to translate computer code data into a series of movement commands for the first and second motors. Furthermore, the controller controls the movement of the marking tip. In the example of the marking tip being movable using electromagnetic means, the controller may send a pulse signal to the power regulator, or direct to the electromagnetic means, to actuate the marking tip and therein punch the tip into the surface of the workpiece.

The marking device may also comprise a communicator 42, such as a wireless communicator (for example, a Bluetooth® module) for receiving and optionally transmitting data. The data primarily comprises instructions (e.g. the computer code) for the controller that are used to instruct the controller to move the first and second motors 18, 20 and the marking pin 22. The communicator 42 is shown to be placed proximal to the power source 40. However, the communicator 42 can be located anywhere inside the housing. The communicator 42 is connected to the controller using cabling (not shown) connected at terminals 52. However, it is understood that the controller and the communicator may be positioned on a single printed circuit board 54, or the like. In another embodiment, the controller 50 may comprise the communicator.

In a preferable embodiment of the marking device, the base 30 comprises a camera window 56. A camera 58 positioned inside the housing 12 so that a fluid seal is formed with the base 30. The camera is used to check the mark produced by the marking head.

The CNC machine arm may comprise a pneumatic supply which is switchable between an on and an off state by the machine. In some embodiments, the marking device comprises a pneumatically operated switch. In these embodiments, connection of the marking device to the machining arm completes a pneumatic circuit wherein the switching of the pneumatic supply operates the pneumatic switch between an on- and an off-state. The pneumatic switch is used to control the power source so the switch turns the marking device on or off. This feature serves a purpose of reducing battery consumption when the marking device is not marking the workpiece.

Alternatively, a Hall-effect reed switch (31—see FIG. 1) may be disposed in the housing, which reed switch 31 is operated when the housing is moved into the vicinity of a magnetic field. The magnetic field may be provided by a simple magnet, for example magnet 33 in FIG. 6, disposed at some convenient location in the CNC machine, and towards which the machining arm can move the marking device 10 when the marking device is to be actuated. The reed switch may be arranged as a toggle switch, so that it may be employed also to deactivate the power source at the end of a marking operation.

The advantage of the latter is that no pneumatic connection is required, which in some CNC machines might not be provided. Also, the switch is entirely located within the housing so it is protected from the environment within the CNC machine. A different switch, however, could be operated in other ways, for example by mechanical operation through the machine arm 600 being arranged to press the housing incorporating a mechanical switch against a stop on the table 640 to actuate and de-actuate the switch.

That is, the marking device may comprise a switch that is actuatable by movement of the machining arm after connection of the marking device to the machining arm, and de-actuatable by corresponding movement when marking of the workpiece has been completed and prior to return of the marking device to the tool array.

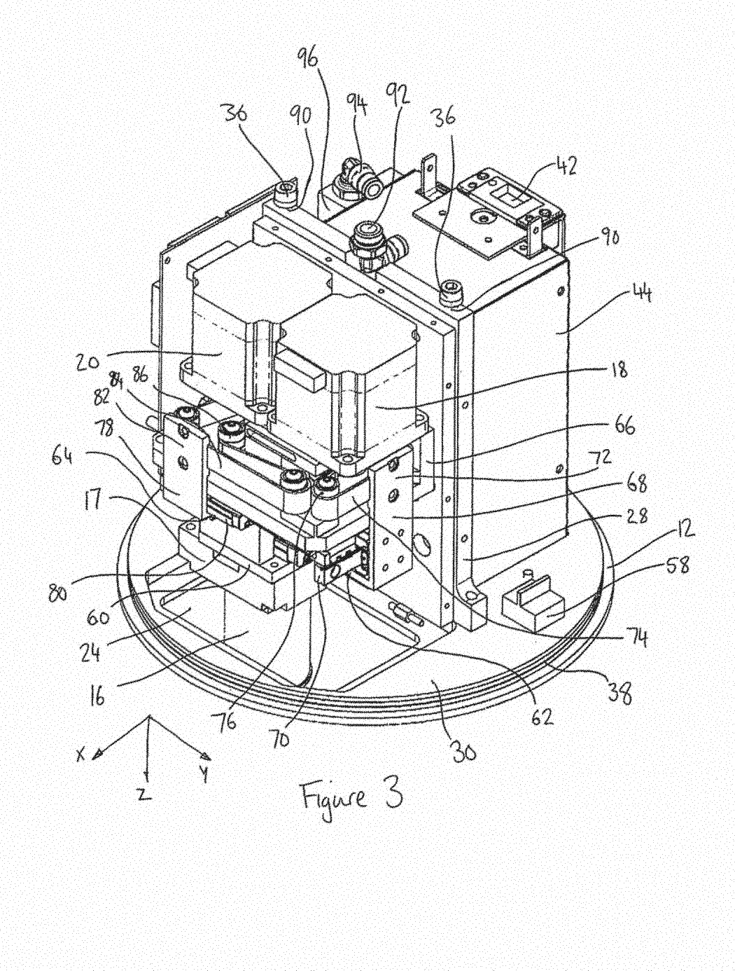

In FIG. 3, the marking head 16 is disposed on a mount 17, forming part of a moving frame 60. The moving frame is slidably attached to a first slide 62 and a second slide 64. The first and second slides are mounted on a frame mount 66. The first slide 62 comprises a first slide bar 68 journalled to slide on a first slide runner 70. An upper portion 72 of the first slide bar 68 is connected to a first belt 74. The first belt 74 runs around an arrangement of pulleys 76 and around a drive shaft (not shown) of the first motor 18. Likewise, the second slide comprises a second slide bar 78 journalled to slide on a second slide runner 80. An upper portion 82 of the second slide bar 78 is connected to a second belt 84. The second belt 84 runs around an arrangement of second pulleys 86 and around a drive shaft (not shown) of the second motor 20. The configuration of the first and second belts allows rotation of the first and second motors to move the first and second slide portions respectively. Thus the moving frame 60 is movable in the x and y direction and therefore within the marking plane.

FIG. 3 further shows bores 90 in the frame 28 configured to receive screws 36 for fixing the lid (see FIG. 1) to the frame 28. The pneumatic connection mentioned above is shown in FIG. 3 to comprise a first connector 92 suitable for attachment to the machining arm and a second connector 94 suitable for attachment to the pneumatic switch 96. Preferably, a flexible pipe (not shown) joins the first and second connectors but the join may comprise any component suitable for use in a pneumatic system.

The pneumatic system may also be used to drive the marking tip. In this configuration, a switched valve, controllable by the controller, would be placed between the pneumatic supply and the marking tip. The supply may be taken from the pneumatic switch or directly from the first connector. The marking head, in this configuration, comprises a piston having a piston head movable in said piston and resiliently biased away from the workpiece. The marking tip is in turn connected to the piston so that on opening of the switched valve, the marking tip is pneumatically forced toward the workpiece and on closing of the switched valve, the marking tip retracts from the workpiece.

To create a mark on a workpiece, the CNC machine of any of the above embodiments performs the method of:
a) selecting the marking device using the machining arm;
b) positioning the marking device over the workpiece;
c) moving the marking head in the marking plane while retaining the position of the marking device; and
d) moving the marking tip in the marking direction to mark the workpiece; and
e) repeating steps c) and d).

Steps a) and b) are performed by the CNC machine under its control (using its own controller, 700 in FIG. 6). Steps c) and d) are performed by the marking controller. The marking controller may be in wireless communication with an external controller 800 in the form of a computer (see FIG. 6) separate from the CNC machine which comprises the requisite software to translate desired marking shapes, such as a dot matrix, into suitable code that enables the marking controller to appropriately perform steps c) and d). Such steps may be repeated for each dot in the dot matrix. The CNC machine (CNC controller 700) may be arranged to notify the computer 800 when the CNC machine has performed steps a) and b) and the marking device is ready to be operated by the computer. Likewise, the computer 800 may be arranged to notify the CNC machine (CNC controller 700) when a marking operation has been completed and the next stage of part processing can be commenced. Generally, this may comprise moving the machined part to another location for processing elsewhere.

Where a camera is included in the marking device 10, a step f) (before notifying the CNC machine that the marking operation has been completed) comprises: positioning the camera of the marking device over the mark made by the marking device 10 so as to obtain an image of the mark. This image may be communicated to the computer which is arranged to detect the image and ensure that it is readable and that what is read corresponds with what was intended.

It is to be understood that part of the reason for employing a marking controller and a marking head that is movable in the marking device in said marking plane is because CNC machines are not readily adapted to produce unique and variable movements at the touch of a button, or especially to move in a fashion to describe a unique and variable dot matrix code. Thus, the present invention requires only that the machining arm is held stationary with said marking plane held at an appropriate distance from, and substantially parallel to, a surface of the workpiece to be marked. Thereafter, the arrangement of the marks on the workpiece made by the marking pin is under the control of the marking controller in the marking device and/or the computer 800 in communication with it.

However, it may well be that such functionality may ultimately become readily available in CNC machines, in which event the marking head may be fixed in said marking device with the machining arm making the necessary movements, under the control of the CNC's controller, to trace the required pattern of movements for the marking device over the workpiece. Nevertheless, in many applications a simplified controller 50 and communicator will still be required because a solenoid actuated marking pin provides the cleanest and most accurate mark in the surface of the workpiece. In many instances, the workpiece will be a highly valued part in which additional stresses are to be avoided where necessary. A precisely weighted single punch to a precise depth ensures a minimum additional stress imposed on the workpiece.

Indeed, in its simplest form, the communicator could be a pneumatic connection where each pulse of air is sensed by the controller as an instruction to effect a punch once the CNC machine has moved the marking head to a desired position. In this arrangement, no external or separate computing is required, since the CNC machine is itself fully enabled. Other forms of communicator are envisaged, such as infra-red or a wi-fi connection, including Bluetooth®.

Until such time as CNC machines are rendered adaptable to move their machining arms in unique and varying patterns, a marking device with the full functionality described above will remain necessary. However, while the arrangement of FIGS. 1 to 3 above works very well in principle, with the marking head constrained to move in single x, y plane, it does result in a fairly large bodied marking device because of the requirement for large motors 18, 20 driving the belts 84, 74 and the carriages 68, 78.

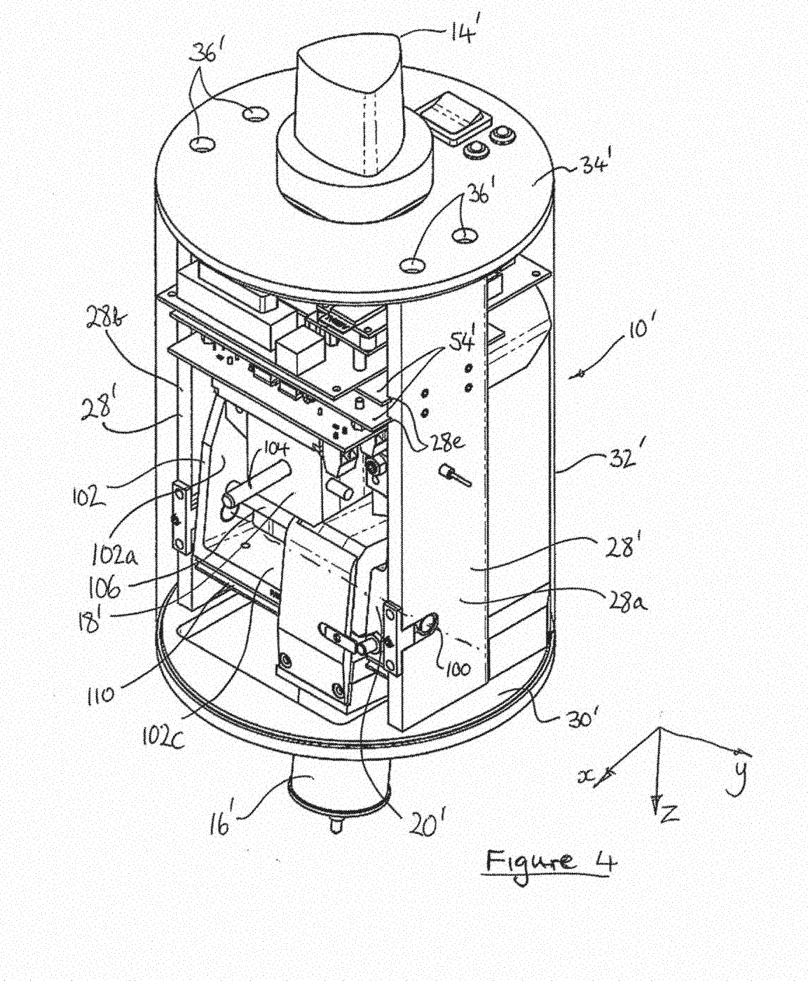

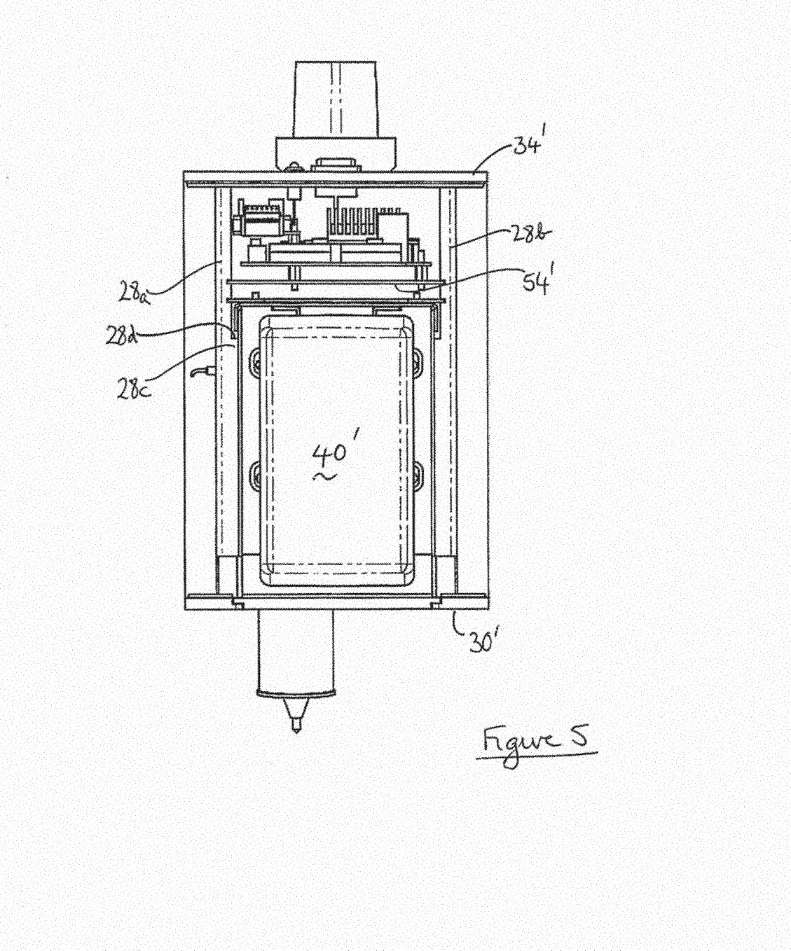

FIGS. 4 and 5 show an alternative arrangement which is more compact because it employs the arrangement of its marking head as disclosed, for example, in WO02/055319. Here, the marking device 10′ likewise has a housing 12′ comprising base 30′ and lid 34′ with a cylindrical body 32′. A frame 28′ is in the form of a shallow U-shaped section having side walls 28a, b and back wall 28c. Side walls 28a, b extend the complete distance between the base 30′ and lid 34′ and are secured thereto by screws 36′. Back wall 28c extends part of the way up from the base 30′, terminating at 28d near the lid 34′ so that circuit boards 54′ may be retained in grooves 28e in the side walls 28a, b, and on which boards the same electrical components as described above with the embodiment FIGS. 1 to 3 are mounted.

However, between the side walls 28a, b is pivoted, about journal axis 100, a tilting frame 102. Between arms 102a, b of the tilting frame 102 is fixed a first motor 18′ which has an armature (not visible) mounted around a first lead screw 104. One end of the first lead screw is fixed axially (with respect to the lead screw) in back wall 28c, so that when the first motor 18′ operates, it screws itself up and down lead screw 104 so as to tilt tilting frame 102 about its journal axis 100.

Independently, a second motor 20′ is likewise disposed around a second lead screw 106 mounted between the arms 102a, b of the tilting frame 102. Around the second motor 20′ is a slide mount 17′ which slides on rails 110 on a base 102c of the tilting frame 102. The slide mount 17′ carries the marking head 16′. When the second motor 20′ operates, it screws itself along the second lead screw 106 in the y direction, taking the marking head 16′ with it. Because the tilting frame pivots, however, the marking head moves in an arc when the first motor operates, so that the surface described by the marking pin when the motors operate is not planar but cylindrical. For most purposes, this is satisfactory.

Otherwise the marking device 10′ is essentially the same. It has a different first connector 14′, a simple on-off switch 111 that is manually operated and LED lights 112 that inform the user that the marking device is live and the state of the battery 40′. However, by employing the tilting arrangement smaller motors can be employed and so the tool has a smaller diameter. It can therefore be employed by more CNC machines.

Throughout the description and claims of this specification, the words “comprise” and “contain” and variations of them mean “including but not limited to,” and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

1. A CNC machine comprising:
a holder for a workpiece to be machined;
a tool array comprising one or more tools;
a machining arm having a first connector and adapted to select and use one of said one or more tools to machine said workpiece;
a CNC controller;
a marking device, positionable in said tool array, comprising:
a second connector;
a housing including a marking controller;
a marking head mounted in said housing, said marking head comprising a marking tip being moveable in a marking direction under the control of said marking controller for marking said workpiece;
a communicator; and
an external controller, for controlling said marking device and including a transmitter unit;
wherein the marking device is selectable from said tool array by said machining arm by interengagement of said first and second connectors under the control of said CNC controller; and
wherein the communicator is configured to receive instructions from the transmitter unit of said external controller, said instructions being passable to said marking controller to activate said marking controller to move said marking tip to mark the workpiece.

2. The CNC machine of claim 1, in which said communicator comprises a wireless communicator.

3. The CNC machine of claim 1, in which said communicator is further adapted to transmit data indicating the current or historic movement of said marking head or said marking tip.

4. The CNC machine of claim 3, in which said external controller is further adapted to receive said data indicating the current or historic movement of said marking head and/or said marking tip.

5. The CNC machine of claim 1, wherein said marking device further comprises a support frame on which said housing is mounted substantially enclosing said support frame, said frame providing a mount for said marking head and said marking controller.

6. The CNC machine of claim 5, in which said housing comprises a body, a base and a lid, wherein said base and said lid are fixable to said frame and said body is positionable between said base and said lid, so that fixation of said base and lid to said support frame clamps said body and forms said housing.

7. The CNC machine of claim 1, wherein said marking tip is moved electromagnetically.

8. The CNC machine of claim 1, wherein said marking device comprises a power source which is activated and deactivated by said machining arm.

9. The CNC machine of claim 8, wherein said marking device comprises a switch to activate and deactivate said power source, the switch activatable by movement of the machining arm after connection of the marking device to the machining arm, and de-activatable by corresponding movement of the machining arm after marking of the workpiece has been completed and prior to return of the marking device to the tool array.

10. The CNC machine of claim 8, wherein said switch comprises a magnetically actuated switch disposed in the housing, activated by being moved into a magnetic field.

11. The CNC machine of claim 1, wherein said housing comprises a window through which said marking head and/or marking tip protrudes, a gaiter being connected between said marking head and said window to fluid-seal said window.

12. The CNC machine of claim 1, wherein the marking head is mounted for translational movement in a marking surface under the control of said marking controller, said marking surface being substantially orthogonal with respect to said marking direction.

13. The CNC machine of claim 12, further comprising a first motor and a second motor, wherein said marking surface is planar and said translational movement is effected by the first motor and the second motor, and wherein said first motor is adapted to move said marking head in a first direction in said marking plane and said second motor is adapted to move said marking head in a second direction in said marking plane, wherein said first direction is substantially perpendicular to said second direction.

14. The CNC machine of claim 6,
wherein the marking head is mounted for translational movement in a marking surface under the control of said marking controller, said marking surface being substantially orthogonal with respect to said marking direction;
wherein said marking surface is planar and said translational movement is effected by a first motor and a second motor wherein said first motor is adapted to move said marking head in a first direction in said marking plane and said second motor is adapted to move said marking head in a second direction in said marking plane, wherein said first direction is substantially perpendicular to said second direction; and
wherein said first and second motors are fixed in the support frame and drive belts that slide a marking head mount in said first and second directions.

15. The CNC machine of claim 6, in which said marking surface is cylindrical and said translational movement is effected by a first motor and a second motor.

16. The CNC machine of claim 6,
wherein the marking head is mounted for translational movement in a marking surface under the control of said marking controller, said marking surface being substantially orthogonal with respect to said marking direction;
wherein said marking surface is cylindrical and said translational movement is effected by a first motor and a second motor; and
wherein said first motor is disposed on a tilting frame pivoted in the support frame, the first motor being arranged to tilt the tilting frame in a first direction with respect to the support frame, and the second motor is mounted on a slide mount slidable by operation of the second motor in a second direction substantially orthogonal with respect to said first direction, the slide mount mounting said marking head.

17. The CNC machine of claim 1, wherein said marking device comprises a power source which is activated and deactivated by said machining arm by one of:
i. a pneumatically actuated switch in the housing, activated by connection of said first and second connectors when said machining arm includes a pneumatic source; and
ii. a magnetically actuated switch in the housing, activated by being moved into a magnetic field.

18. A method of marking a workpiece in a CNC machine comprising:
a holder for said workpiece;
a machining arm adapted to select and use a tool to machine said workpiece under the control of a CNC controller;
an external controller including a transmitter; and
a marking device selectable by said machining arm, said marking device comprising a marking head having a marking tip being movable in a marking direction under the control of a marking controller, and a communicator connected to said marking controller;
said method comprising the steps of:
a) the CNC controller controlling said machining arm to select said marking device;
b) the machining arm positioning said marking device with respect to said workpiece;
c) the external controller communicating with said communicator to activate the marking controller to effect marking by the marking device; and
d) the marking controller controlling movement of said marking tip in said marking direction to produce a mark on said workpiece.

19. The method of claim 18, in which said marking head is movable in the marking device in a marking plane being substantially orthogonal with respect to said marking direction, the method further comprising the step of:
e) before step d), the controller moving said marking head in said marking plane while retaining the position of said marking device.

20. The method of claim 19, further comprising the step of:
f) Repositioning said marking device using the CNC controller so that a camera of said marking device is able to obtain an image of said mark.

21. The method of claim 19, in which step b) further comprises activating a power source in the marking device.

22. The method of claim 21 wherein said activation of the power source is effected by one of:
i. pneumatic actuation of a switch in the marking device by the machining arm under the control of the CNC controller; or
ii. actuation of a magnetically operated switch in the housing by the machining arm, under the control of the CNC controller, moving the magnetically operated switch through a magnetic field.

23. The method of claim 21, in which the method further comprises:
i. transmitting a signal from said communicator to said external controller to indicate that said marking device has been activated;
ii. transmitting said instructions from said external controller to said marking device; and
iii. transmitting a signal from said communicator to said computer to indicate that said mark has been produced.

24. The method of claim 23, further comprising the step of:
i. under the control of the CNC controller, repositioning said marking device so that a camera of said marking device is able to obtain an image of said mark, wherein:
ii. transmitting a signal from said external controller to said marking device containing further instructions for said marking controller to operate said camera to obtain said image;
iii. transmitting said image from said marking controller to said external controller, and
iv. said external controller checking said image.

25. The method of claim 24, wherein, after checking said image, said external controller notifies the CNC machine that the power source is to be deactivated.
